(19) United States
(12) Patent Application Publication
(10) Pub. No.: US 2012/0291335 A1
(43) Pub. Date: Nov. 22, 2012

(54) Fish Livewell and Padding System Therefor

(76) Inventors: Thomas C. BROOKE, Campbellford (CA); Bruce L. Tufts, Elginburg (CA)

(21) Appl. No.: 13/476,014

(22) Filed: May 21, 2012

Related U.S. Application Data
(60) Provisional application No. 61/487,870, filed on May 19, 2011.

(51) Int. Cl. A01K 97/00

(52) U.S. Cl. 43/55

(57) ABSTRACT

This invention provides a livewell for storing and/or transporting live fish, and an insert for a livewell, including a padding system that is disposed between at least one wall of the tank one or more fish. The livewell or the insert may include one or more sensors, wherein the one or more sensors provide monitoring of oxygen, temperature, pH, and/or ammonia in the water of the livewell. The livewell or the insert may further include apparatus that performs at least one function selected from circulating, oxygenating, filtering, and chilling water in the livewell, optionally in accordance with at least one corresponding sensor. The padding system may include one or more portions that divide the livewell into two or more chambers, each chamber adapted to accommodate a fish. In one embodiment, the padding system comprises at least one pouch adapted to accommodate a fish.

### RELATED APPLICATION

This application claims the benefit of U.S. Patent Application No. 61/487,870, filed on 19 May 2011, the contents of which are incorporated herein by reference in their entirety.

### FIELD

The invention relates generally to transportation systems for live fish. In particular, the invention relates to padding systems for livewells that maintain fish in good physical condition.

### BACKGROUND

In recreational fishing, an angler has the choice to keep his or her catch for later consumption or to release the fish. Releasing the fish alive after capture is known as live-release angling. Live-release angling is a popular and effective management tool that allows responsible anglers to utilize the resource without over-exploitation.

Tournament angling is ever-growing in popularity and with its growth is the increasing potential to negatively impact fish populations. For example, the North American bass fishing tournament was first documented in 1955 in Texas, and since that time, the sport has grown across the United States and Canada. A survey in 1991 estimated that 30,000 events take place annually in North America targeting the black basses (Micropterus spp.) which include Largemouth bass (Micropterus salmoides) and Smallmouth bass (Micropterus dolomeui) (Kerr, S. J. 1999. A survey of competitive fishing events in Ontario. Technical report TR-114, Southcentral Sciences Section, Ontario Ministry of Natural Resources, Kemptville, Ontario. 11p+Appendices). Tournaments are also commonly held for a variety of other species such as Walleye (Sander vitreus), Muskellunge (Esox masquinongy), and Northern pike (Esox lucius).

Such tournaments and events vary in species targeted, size and type of water body, number of anglers competing, number of sponsors, level of professionalism, purpose of tournament (some are fundraisers), size and types of prizes, etc. However, most tournament fishing typically follows a similar general pattern. A pre-set number of fish (e.g., five in Ontario to adhere to Ministry of Natural Resources regulations) which exceed a minimum size (generally 30 cm for the black basses) are captured using a rod and reel. Once the fish are captured, they are transferred to aerated holding tanks (referred to hereinafter as livewells) which are typically inboard or incorporated into the hull of a boat. A pre-set time is established when all of the anglers must return to a final check-in point. The fish are then usually brought up on land in large plastic bags filled with water and held in aerated tanks until they are brought to the weigh scale. After the fish are weighed, they are transported to a live-release boat with large holding tanks. The fish are then brought to a pre-determined release point and set free. In the case of a multiple-day tournament, the daily weights are totaled for an overall result.

The potential negative impacts of live-release angling on the resource can be minimized by ensuring that fish are in good condition at release. For example, factors that negatively affect the condition of fish in a livewell may be related to water quality, and may include presence of excretory wastes, reduced level of dissolved oxygen, reduced pH due to carbon dioxide added during respiration, and elevated temperature. Corrective measures typically include exchanging the water in the livewell with fresh water and aerating the water to allow for some additional oxygen diffusion. However, low oxygen level and elevated temperature may not be adequately addressed by such measures in all conditions to which fish are exposed during livewell transportation. Physical factors such as fish size may also play a role, where larger fish are generally more susceptible to physiological stress in a crowded environment than smaller fish. In spite of such factors being addressed, there is a need for improved livewell conditions.

### BRIEF DESCRIPTION OF THE DRAWINGS

For a better understanding of the invention, and to show more clearly how it may be carried into effect, embodiments will be described, by way of example, with reference to the accompanying drawings, wherein:

FIG. 1 is a plot showing the projected number of impacts fish with the walls of a livewell during a 60 minute transportation experiment.

FIG. 2 is a plot showing the amount of plasma lactate dehydrogenase (LDH, log₁₀ mmol/L) in different experimental groups of fish. The (*) symbol indicates an experimental mean that is significantly different from the control mean (Dunnett's test, P≦0.05). The (+) symbol indicates an experimental mean that is significantly different from the angled mean (Dunnett's test, P≦0.05).

FIG. 3 is a plot showing the amount of plasma creatine phosphokinase (CPK, log₁₀ mmol/L) in different experimental groups of fish. The (*) symbol indicates an experimental mean that is significantly different from the control mean (Dunnett's test, P≦0.05). The (+) symbol indicates an experimental mean that is significantly different from the angled mean (Dunnett's test, P≦0.05).

FIG. 4 is a plot showing the mean number of impacts experienced by fish per minute and the amount of water activity measured inside an experimental livewell during transportation, represented by force in 0.84 ft²/lb/sec.

FIG. 5 is a plot showing the Log₁₀ level of plasma lactate dehydrogenase (LDH) in mMol/L as a function of the mean number of impacts per minute of smallmouth bass with the walls of a livewell (squares, with a padding system installed in the livewell; diamonds, no padding system).

FIG. 6 is a plot showing the Log₁₀ level of plasma creatine phosphokinase (CPK) in mMol/L as a function of the mean number of impacts per minute of smallmouth bass with the walls of a livewell (squares, with a padding system installed in the livewell; diamonds, no padding system).

### SUMMARY

Described herein is a livewell for storing and/or transporting live fish, comprising: a tank comprising walls adapted to contain water and one or more fish; and a padding system; wherein the padding system is disposed between at least one wall of the tank and the one or more fish.

The livewell may comprise means that circulates and/or oxygenates and/or filters and/or adjusts temperature of water in the livewell. The livewell may comprise means that removes used water from the livewell and adds unused water to the livewell, wherein a total volume of water in the livewell is maintained substantially constant.

The padding system may substantially cover at least one wall of the livewell, such as a wall that is proximal to the head of a fish in the livewell. The padding system may substantially cover two walls of the livewell, such as walls that are proximal to the head and tail of a fish in the livewell.

The padding system may include one or more portions that divide the livewell into two or more chambers, each chamber adapted to accommodate a fish of a selected size range such that a longitudinal axis of a fish is maintained substantially in alignment with a longitudinal axis of a chamber. The padding system may be adapted to be removed from the livewell with a fish therein.

The livewell may further comprise one or more sensors; wherein the sensors provide monitoring of at least one parameter of the water in the livewell, wherein the at least one parameter is selected from oxygen level and temperature.

Also described herein is an insert for a livewell for storing and/or transporting live fish, comprising: a padding system; wherein the padding system is adapted to be disposed in the livewell between at least one wall of the livewell and one or more fish.

The insert may comprise one or more fasteners that maintain the padding system in place in the livewell. The padding system may substantially cover at least one wall of the livewell, such as a wall that is proximal to the head of a fish in the livewell. The padding system may substantially cover two walls of the livewell, such as walls that are proximal to the head and tail of a fish in the livewell.

The padding system may include one or more portions that divide the livewell into two or more chambers, each chamber adapted to accommodate a fish of a selected size range such that a longitudinal axis of a fish is maintained substantially in alignment with a longitudinal axis of a chamber. The padding system may be adapted to be removed from the livewell with a fish therein. At least a portion of the padding system may be adapted to be removed from the livewell with a fish therein.

The insert may further comprise one or more sensors associated with the padding system; wherein the sensors provide monitoring of at least one parameter of the water in the livewell, wherein the at least one parameter is selected from oxygen level and temperature.

Also described herein is a method for storing and/or transporting live fish, comprising: placing fish in a tank comprising walls that contain water and a padding system; disposing the padding system between at least one wall of the tank and the fish; wherein the padding system protects fish against impacts with the walls of the tank.

The method may include configuring one or more portions of the padding system to divide the tank into two or more chambers, each chamber adapted to accommodate a fish of a selected size range such that a longitudinal axis of a fish is maintained substantially in alignment with a longitudinal axis of a chamber.

The method may comprise providing one or more sensors with the padding system or the tank; wherein the sensors provide monitoring of at least one parameter of the water in the livewell, wherein the at least one parameter is selected from oxygen level and temperature.

The method may include removing the padding system or a portion thereof from the tank with a fish therein. In accordance with the method, the tank may be a livewell of a fishing boat and the padding system may be adapted to be inserted into and removed from the livewell.

Also described herein is a livewell for storing and/or transporting live fish, and an insert for a livewell, including a padding system that is disposed between at least one wall of the tank one or more fish. The livewell or the insert may include one or more sensors, wherein the one or more sensors provide monitoring of oxygen, temperature, pH, and/or ammonia in the water of the livewell. The livewell or the insert may further include apparatus that performs at least one function selected from circulating, oxygenating, filtering, and chilling water in the livewell, optionally in accordance with at least one corresponding sensor. The padding system may include one or more portions that divide the livewell into two or more chambers, each chamber adapted to accommodate a fish.

In one embodiment, the padding system comprises at least one pouch adapted to accommodate a fish. Further embodiments include a means for stabilizing the at least one pouch in the livewell. In one embodiment the means for stabilizing the at least one pouch includes a keel, a floatation component, or a combination thereof. In another embodiment the means for stabilizing the at least one pouch includes one or more members that substantially span a length and/or width of the livewell, and/or one or more members associated with one or more walls of the livewell; wherein the at least one pouch is removably attachable to the one or more members. In one embodiment at least one pouch is adapted to be removably attached to at least one other pouch.

In another embodiment at least a portion of the padding system is adapted to be removed from the livewell with a fish therein. In one embodiment the portion of the padding system that is adapted to be removed from the livewell with a fish therein is a pouch.

Also described herein is a method for storing and/or transporting live fish, comprising: placing fish in a livewell comprising walls that contain water and a padding system; and disposing the padding system between at least one wall of the livewell and the fish; wherein the padding system protects fish against impacts with the walls of the livewell.

The method may include substantially covering at least one inside wall of the livewell with the padding system. The method may include configuring the padding system to divide the livewell into two or more chambers, each chamber adapted to accommodate a fish. The method may include providing one or more sensors with the padding system or the livewell; wherein the one or more sensors provide monitoring of at least one parameter of the water in the livewell; wherein the at least one parameter is selected from oxygen, temperature, pH, and ammonia. The method may include one or more of circulating, oxygenating, filtering, and chilling water in the livewell so as to maintain the at least one parameter at, above, or below a selected level, or within a selected range; optionally wherein one or more of circulating, oxygenating, filtering, and chilling water is carried out when a level of the at least one parameter is sensed to deviate from the selected level or the selected range.

The method may include removing the padding system or a portion thereof from the livewell with a fish therein. In one embodiment the method may comprise placing a fish in a pouch of the padding system.

The method may include providing a means for stabilizing the at least one pouch in the livewell. In various embodiments this may include providing a keel or a floatation component associated with the at least one pouch, or a combination thereof; and/or providing one or more members that substantially span a length and/or width of the livewell, and/or one or more members associated with one or more walls of the livewell; wherein the at least one pouch is removably attachable to the one or more members. The method may include removably attaching together two or more pouches.

### DETAILED DESCRIPTION OF EMBODIMENTS

Livewells currently in use are not always effective in preserving live fish in good condition. The walls of livewells are typically made of a hard material such as plastic, fiberglass, or steel. When in a moving boat, the water in the livewell moves (i.e., “sloshes”), and accordingly fish in the livewell are subjected to such movement, causing them to collide with walls of the livewell. Studies conducted by the inventors indicate that in a typical fishing event, fish in a livewell may hit the walls of the livewell hundreds of times. The problem is exacerbated when boats are travelling at higher speeds, and/or in rough water, to the extent that fish in such a livewell may sustain serious physical injury from hitting the walls of the livewell.

For example, physical injury such as bruising of the lips and fin rays, lacerations on the body, and broken or separated spiny fin rays may be sustained by fish maintained and transported in such currently-available livewells. In some cases these injuries are inflicted by the water inside the livewell moving erratically and causing impacts between fish and the wall. Lacerations on the body may be caused by impacts between fish when water is violently sloshed around the tank. In addition, fatigue may result from fish resisting the water movement. If a fish is severely fatigued, it may no longer be able to maintain equilibrium (i.e., remain upright) in the water column. The end result can be an unresponsive fish that is floating on its side or upside-down in the tank. In a situation like this, the fish may be susceptible to further damage due to the mechanical action or sloshing of the water inside the tank.

This invention is based, at least in part, on the recognition that storage and transportation of fish in a livewell can negatively affect the physical condition of the fish. Whereas it has been known that factors related to water quality, such as presence of excretory wastes, reduced dissolved oxygen, reduced pH due to carbon dioxide added during respiration, and elevated temperature, negatively affect the condition of fish in a livewell, little has been done to address these factors in currently-available livewells. Furthermore, there has been little attention to factors that affect the physical condition of fish, such as impact of fish with the walls of a livewell.

Thus, one aspect of the embodiments described herein is the provision of a livewell that reduces negative effect of water turbulence or sloshing in the livewell, as well as reduces the potential for physical harm to the fish resulting from impact with the wall of the livewell. As described herein, a padded livewell system protects fish by reducing physical injury caused by collisions between the fish and with the walls of the livewell. Another aspect of the embodiments described herein is the provision of means for sensing and/or monitoring and or adjusting parameters such as oxygen level and temperature of water in a livewell.

A product that attempts to address the problem of physical injury to live fish during transportation is the Glory Bag™. This product is analogous to a pencil case for a fish, in which the fish is held during transportation. However, the product provides little or no protection for the fish should they strike the wall of a livewell while held therein. Furthermore, because a fish is severely constrained in the bag, additional problems may be introduced. For example, the fish may be stressed, respiration may be inhibited, and because the fish cannot swim or properly use its fins, it cannot perform basic behavioural responses such as maintaining proper orientation in the water column (i.e., it may be upside down), which leads to further physiological problems. Clearly a better solution is needed.

In accordance with one embodiment there is provided herein a padding or shock-absorbing system comprising an insert that may be disposed into an existing livewell. Such an embodiment, also referred to herein as an insert, provides an inexpensive option for improving a livewell (i.e., a retrofit), avoiding the need to replace the livewell.

In accordance with another embodiment there is provided a livewell having a padding or shock-absorbing system on one or more interior walls. The padding may be removable for cleaning and for replacement if/when required.

In these embodiments, the padding system does not substantially obstruct or impede the flow of water within the livewell, and the padding system may be provided with perforations, netting, and the like, appropriately placed to achieve this purpose. For example, a padding system such as an insert for an existing livewell design may be provided with such perforations or netting specifically located so as not to substantially obstruct or impede the flow of water within the livewell. To this end, insertable padding systems as described herein may be provided to be compatible with existing livewell designs.

In the embodiments described herein, the padding systems are easily installed and removed to facilitate cleaning thereof, as well as cleaning of the livewell. A padding system may be held in place in a livewell by a press fit or friction fit, and may include one or more internal or external frame members. A padding system may also be held in place in a livewell by suspension or anchoring using clips, fasteners, suction cups, elastic (e.g., spring) members, Velcro™, magnets, and the like, generally referred to herein as “fasteners”, wherein such fasteners do not present any threat of injury to fish in the livewell.

Embodiments as described herein may comprise a flexible membrane made of a material such as a plastic or rubber. The fasteners may be adapted to hold the membrane at a distance from the inside walls of the livewell, such that padding is provided by flexing of the membrane toward the walls in the event of a fish contacting the membrane. Other embodiments may comprise a cushion material associated with the membrane. For example, open- or closed-cell foam material, or a combination thereof, may be associated with (e.g., bonded) one side of the membrane, such that the foam material is disposed between the membrane and the livewell wall when the padding system is installed. In other embodiments, the cushion material may be enclosed within the membrane. Such an embodiment may facilitate cleaning of the padding system. In other embodiments, the membrane may form one or more closed compartments (i.e., a bladder) filled with air or water. The extent to which such an embodiment is filled with air or water may be adjusted, as it may be necessary to adjust the amount of air or water inside the padding system according to the size of the fish housed in the livewell. For example, large fish may require firmer padding than small fish. In other embodiments the size of one or more compartments formed by the padding system in a livewell may be adjusted by inflating/filling one or more such bladders.

In further embodiments the padding system may be adjusted or reconfigured to add or remove compartments by adding/removing sections. For example, the padding system may include one or more dividers or baffles that at least partially divide the livewell into two or more compartments. The dividers or baffles may be flexible and may or may not include padding. The compartments may be sized to accommodate single fish, and thus may be used to isolate fish when multiple fish are maintained in the same livewell. Such an embodiment prevents fish from colliding with each other in the livewell, facilitates easy retrieval of individual fish, and may also reduce stress associated with two or more fish being housed in close proximity. The dividers may be arranged so as to avoid any substantial obstruction of water flow within the livewell. For example, the dividers may be substantially aligned in the direction of water flow within the livewell.

In some embodiments the padding system or a portion thereof maybe removable with a fish held therein. Such an embodiment may include one or more handles to facilitate such use. Such an embodiment may allow a fish to be weighed while contained therein, and reduces or minimizes handling of fish.

In accordance with these aspects and features of the invention, further provided herein is a padding system for holding fish individually in a livewell. The padding system comprises one or more pouches or sleeves for holding a fish. Each pouch is made of a soft, flexible material such as foam, rubber, or plastic, that is thick and soft so as to provide padding, but at the same time is semi-firm so as to hold a selected shape and thus avoid collapsing on the fish and impeding respiration by inhibiting gill movements, as well as permit the fish to move its fins. There may be more padding at the head and tail ends of a pouch to protect the fish if the pouch moves within the livewell. Many openings are provided to allow free movement of water through the pouch.

Pouches as described herein may be provided in a range of sizes to accommodate various sizes of fish. Additionally or alternatively, pouches may be provided in shapes characteristic of different species of fish. For example, a pouch for Muskellunge and Northern pike (Esox) would be more elongated than a pouch for a bass (Micropterus). Further, where multiple pouches are used, they may be provided in different colours, or in sets of colours, e.g., to identify fish caught by different anglers, or fish caught in different locations, or to identify fish for release upon capture of a larger fish (i.e., “culling”). It will be appreciated that a pouch containing a fish may be removed from the livewell so that the fish can be weighed while protected in the pouch.

A padding system comprising one or more pouches as described herein may include one or more features to stabilize the pouch in the water, when empty and/or with a fish therein. For example, a pouch may optionally be provided with a weighted or heavier lower portion (i.e., a keel) on the bottom so as to maintain the pouch in an upright position in the water column. Alternatively or additionally, the upper portion(s) of a pouch may optionally be provided with a floatation component so as to maintain the top of the pouch substantially at the water surface. Pouches may include a handle, and in some embodiments the floatation component may also provide this function.

Further optional features of a padding system as described herein provide for removably attaching multiple pouches to one another and/or attaching one or more pouches to a fixture within the livewell, or to the livewell itself. It will be appreciated that such features also help to stabilize pouches in the water of the livewell. For example, each pouch may be provided with one or more clips, fasteners, suction cups, elastic (e.g., spring) members, Velcro™, magnets, and the like, generally referred to herein as “fasteners” so as to permit such attachment. In one embodiment a “filing” system of fish pouches is provided wherein multiple pouches are removably attached. The filing system may be a floating system and may include members, either floating or permanently or removably attached to walls of the livewell, that span the length and/or width of the livewell, and/or that are associated with walls of the livewell, to which one or more pouches may be attached, and multiple pouches may be organized, e.g., by colour, size, etc. The members may provide or allow for providing additional padding to areas surrounding the attached pouches, to provide further protection. A pouch system as described herein may be used in any livewell; for example, as a retrofit to an existing livewell. In particular, a livewell may be designed and constructed with members, fasteners, etc., as required to accommodate a padding system including one or more pouches.

In further embodiments one or more sensors are disposed in the livewell. In one embodiment one more sensor is disposed in or on the padding system. For example, an oxygen sensor may be disposed so that the oxygen level (e.g., oxygen concentration) in the water of the livewell can be monitored. Alternatively or additionally, a temperature sensor may be disposed so that the temperature of the water in the livewell can be monitored. Other sensors for monitoring other parameters may similarly be disposed in the livewell, optionally associated with the padding system.

Such sensors may provide a direct readout of the level of the parameter, such as oxygen or temperature, being monitored, and may include a visual and/or audible alarm to indicate when a parameter risen/fallen below a critical value. The critical value may be programmed into the sensor. Such sensors may include hardware for remote monitoring of measured parameters. For example, hardware may communicate with the sensors over wires or wirelessly and be conveniently located/installed in the dashboard or control area of a boat, so as to allow monitoring while operating the boat. In further embodiments the sensors and/or hardware may interface with existing systems of a boat.

A livewell as described herein, or an insert for a livewell as described herein, may include one or more apparatus that carries out one or more functions such as circulating, oxygenating, filtering, and adjusting temperature (e.g., chilling) of water in the livewell. In one embodiment one or more such functions may be achieved using apparatus including a pump that removes used water from the livewell and adds unused water to the livewell, wherein a total volume of water in the livewell is maintained substantially constant. Such an embodiment may be configured so that the pump is on substantially continuously, or on for preset intervals, or so that the pump communicates with one or more sensors, wherein, when the level of a sensed parameter (e.g., oxygen, ammonia, temperature, pH, etc.) is determined to be above or below (as the case may be) a critical or selected level or outside of a selected range, the pump is switched on and used water in the livewell is at least partially replaced with unused water, i.e., water from the lake, river, etc. where the fish are caught.

Additionally or alternatively, one or more other apparatus may be employed to carry out one or more of the above-mentioned functions. For example, an air pump may be used to inject air into the water in the livewell, thereby oxygenating the water, and/or a chiller may be used to chill the water in the livewell. Such apparatus may be configured to communicate with one or more sensors, wherein, when the level of a sensed parameter (e.g., oxygen, temperature, etc.) is determined to be above or below (as the case may be) a critical level or outside of a selected range, the apparatus is switched on and the parameter(s) of the water in the livewell substantially restored to an acceptable level(s).

In the above embodiments including one or more apparatus for carrying out one or more function such as circulating, oxygenating, filtering, and adjusting temperature of water in the livewell, it is preferable that the apparatus does not run continuously in installations where the required electrical power is provided by battery. In such a case, an automated system, wherein the apparatus is switched on when the level of a sensed parameter is above or below a critical level, as described above, is preferred.

The embodiments described herein provide protection for fish in livewells, while allowing the fish to function normally, unlike the above-mentioned Glory Bag. Relative to currently available livewells, the embodiments have a dramatic effect on preserving the condition of fish during live transportation. In fishing competitions anglers may be penalized if fish die, and must therefore do everything they can to keep fish in good condition. The embodiments described herein preserve the condition of fish and therefore are of considerable value to anglers in tournaments.

It will be appreciated that a padding system as described herein may be adapted for large scale use as in commercial fishing boats. There are applications where production in fish processing operations depends on a supply of fresh fish from fishing fleets, wherein fish have to be delivered to the processors (and thereafter to the consumer) in top quality condition. The sushi market is one example of such an application. A padding system as described herein may easily be scaled up for use in such a commercial application.

The inventors have collected substantial scientific data that convincingly shows the problems of typical livewells discussed above, and how the problems are addressed by embodiments as described herein. These data are presented in the following non-limiting example.

The contents of all cited publications are incorporated herein by reference in their entirety.

The embodiments are further described by way of the following non-limiting example.

### Example

To date, few studies have characterized physiological damage to fish caused by movement of water within a livewell. Accordingly, experiments were done under real conditions on a lake to properly observe fish under conditions they are subjected to during a typical fishing tournament.

### 1. Fish Collection

Smallmouth bass were angled on Lake Ontario from August to mid-November of 2009 and June to mid-August of 2010. Ambient surface water temperatures ranged from 14.3° C. to 25.0° C. Fish were angled using synthetic lures. Only fish that exceeded 30 cm in total length and 700 g in weight were kept for experiments. These criteria for fish size were used so as to adhere to tournament standards and to ensure that the fish were similar to fish held in livewells by professional anglers in real tournaments.

### 2. Blood Collection

Approximately 3 mL of blood was taken from all specimens using a 3 mL syringe and 22 gauge needle rinsed in a heparinized saline solution (Morrissey et al. 2005). To obtain blood samples, fish were anesthetized in a mixture of clove oil (a naturally occurring substance) and lake water at a concentration of 0.06 mL of clove oil for every 1 L of lake water (Anderson et. al. 1997). Blood was taken from the branchial artery on the first gill arch on the left side of the fish. The blood was immediately placed in two 1.5 mL microcentrifuge tubes and spun in a centrifuge at 10,000× gravity for 3 minutes. The plasma was then immediately removed using a pipet and placed in a 1.5 mL microcentrifuge tube. All tubes were then frozen in dry ice for transport to the lab, then transferred to a −80° C. freezer for storage until processing.

### 3. Plasma Analysis

Plasma samples were analyzed spectrophotometrically at a wavelength of 340 nm, for lactate dehydrogenase (LDH) using the method outlined by Wroblewski and LaDue (1955), and for creatine phosphokinase (CPK) following the method outlined by Hørder et al. (1990). Briefly, a change in the concentration of a known amount of NADH (nicotinamide adenine dinucleotide, reduced) was used to quantitatively estimate the activity levels of both LDH and CPK which both act as catalysts to the following reactions:

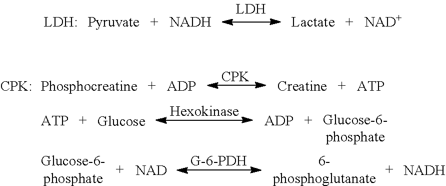

In both cases, the enzymes of interest occur in direct proportion to the amount of NAD⁺ (nicotinamide adenine dinucleotide) present in the substrate.

### 4. Experimental Livewell

A clear 72 L Plexiglass™ livewell was constructed to simulate a livewell that would be found in a tournament-style fishing boat, and is referred to hereinafter as the experimental livewell. The experimental livewell incorporated a pressure sensor to facilitate recording of water movement therein, to characterize the amount of water turbulence that was experienced by fish that were placed inside, and to allow video recording of the transportation. Additionally, the experimental livewell was equipped with a pump to ensure a constant supply of fresh water. At the front or bow-oriented end of the experimental livewell, a digital load cell (Loadstar™ Tr. 400) was mounted externally to record water activity. A 5 cm diameter hole was tapped through the end of the experimental livewell and a threaded bolt was attached to the receiver of the sensor through the hole in the experimental livewell. To prevent water loss, a 7.5 cm gasket was mounted around the perimeter of the hole. A panel of Plexiglass sized to fit over the inside front wall was then attached to the top of the bolt which ran to the sensor. The pressure sensor measured the weight shift of the water inside of the experimental livewell to characterize the relative amount of turbulence the fish experienced over the course of an experiment. Another gasket was glued to the top of the perimeter of the experimental livewell and a clear Plexiglass top was fitted to prevent water loss. Two wide-angle, waterproof digital video cameras (GoPro™ Hero™) were mounted at the front and back of the experimental livewell to observe and record the orientation and activity of the fish. To ensure that there was adequate dissolved oxygen for the fish and no significant build-up of excretory wastes, a 12 volt bilge pump (Seasense™ 600 gallon/hour) was bracketed into the bottom back corner of the experimental livewell and a 2.5 cm diameter plastic hose was run from the bilge pump through a hole drilled in the top of the experimental livewell into the inboard livewell of the boat. Another 12 volt bilge pump was bracketed into the livewell of the boat and a hose was run back into the experimental livewell through a second hole drilled in the top of the experimental livewell. Both bilge pumps were powered by a 12 volt deep-cycle marine battery strapped under the console of the passenger side of the vessel. The water in the livewell of the boat was then replaced with fresh lake water by an integrated pump built into the hull of the vessel ensuring a constant supply of fresh water in the experimental livewell. A digital thermometer was attached to the interior of the experimental livewell to monitor the water temperature during an experiment. At no time did the water temperature change by more than 2° C. between the beginning and the end of an experiment.

### 5. Livewell Transportation Group

Experiments were performed to simulate the transport of fish (Smallmouth bass) in livewells as in a tournament situation. The purpose of these experiments was to evaluate the amount of physical and cellular disturbance caused by the mechanical action of water turbulence inside a livewell. Lake water was collected from the surface of Lake Ontario and poured into the experimental livewell to a depth of 10 cm below the rim. A maximum of three fish were placed inside the experimental livewell during a trial, and the top was secured. The fish were then transported for 60 minutes from their point of capture to a docking point. The fish were then placed in a different, dark and aerated holding tank for a period of 6 hours. This period of time was used to simulate an average holding time of fish in a livewell under tournament conditions. After the 6 hour holding period, the fish were sampled using the methods described above, rehabilitated and released.

### 6. Padded Treatment Group

A second experimental series was conducted to determine if the damage caused by impacts between fish and the wall of the tank was reduced by padding the interior walls of the experimental livewell. These experiments were identical to those described above with the following exception: In these experiments, 5 cm thick layer of soft foam was added to the interior of the front and rear of the experimental livewell to absorb the impact between fish and the wall of the experimental livewell. For these experiments, nine fish were angled from Lake Ontario and transported in the padded experimental livewell using the methods and equipment described above.

### 7. Control Group

Six fish were collected from Lake Ontario by angling using synthetic bait; these fish were immediately sampled with no further handling. The purpose of this group was to obtain a blood sample before the intracellular enzymes used as indicators of cellular damage in this study would have had an opportunity to become significantly elevated in the blood stream. These samples provided values that should be very close to those in undisturbed fish in the wild. A second group was collected by angling five Smallmouth bass from Lake Ontario and holding them in a darkened, circulated, and aerated holding tank for six hours before sampling. This group was collected to provide some insight into the relative amount of cellular damage that is caused by the simple act of angling the fish without significant livewell transport. Research suggests that angling causes increases in muscle and plasma lactate (Suski 2004) but there has been no evaluation of the impact of angling on the indicators of cellular damage used in this study (Referred to as ‘Angling’ group).

### 8. Tournament Sample Group

Samples were also collected at a professional bass fishing tournament (Big Jim Pro-Am) on Lake Ontario that took place in September 2009, to determine the levels of LDH and CPK found in Smallmouth bass after a typical professional angling event held on a large body of water. In this case, six Smallmouth bass were randomly selected from the live-release boat at the event.

### 9. Results

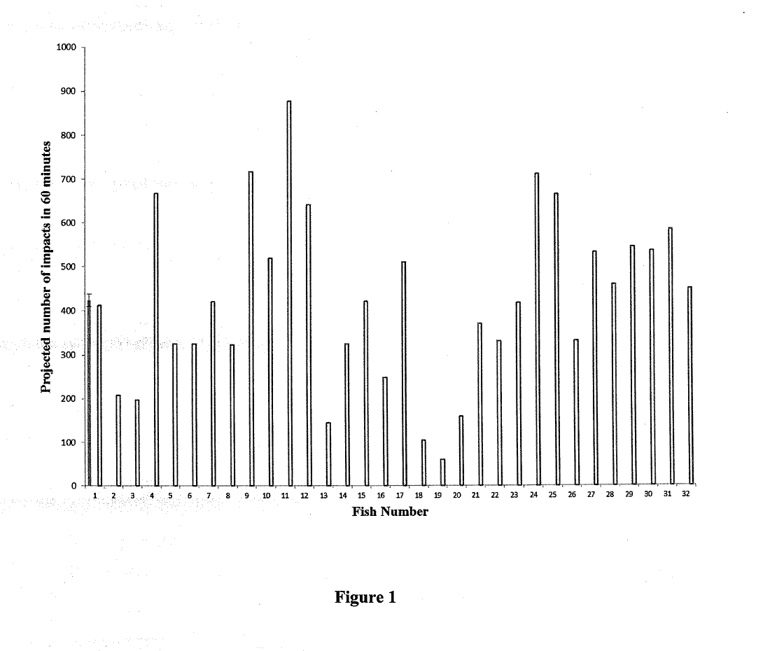

FIG. 1 shows the projected number of impacts of fish with the walls of the experimental livewell during the 60 minute transportation experiment. The data were obtained from recorded videos of the fish in the livewell. Because all fish in the livewell were not visible in the videos during the entire 60 minutes, projections based on the mean number of impacts per minute were calculated. The mean of this calculation was over 400 impacts per hour. The data show that only one fish impacted with the walls of the livewell less than 100 times over the experiment.

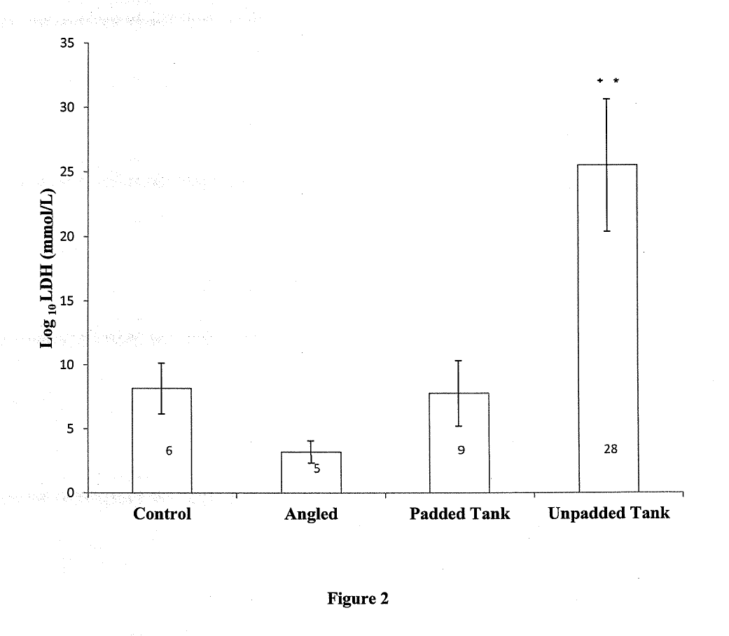

In FIG. 2 the levels of LDH in the control, angling, padded, and unpadded treatment groups are shown. The unpadded group showed significantly higher levels of LDH than both the control and angling groups, whereas the padded treatment group did not show a significantly higher level of LDH than either the control or the angling groups.

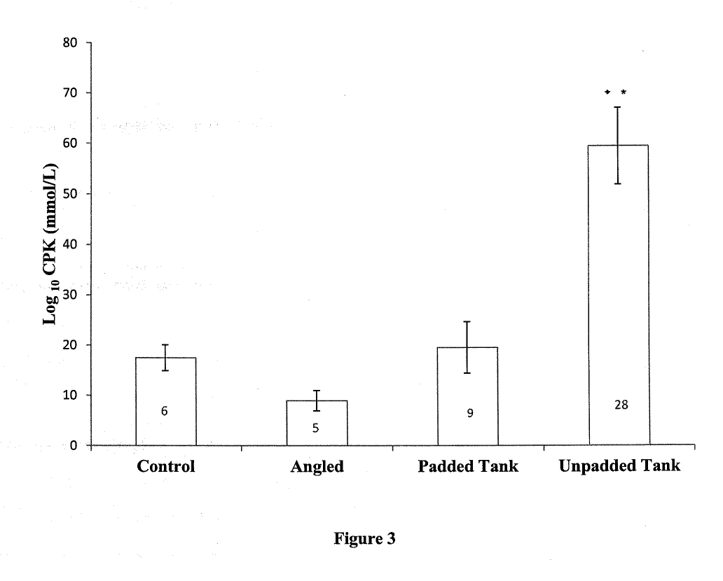

FIG. 3 shows a similar trend in that the unpadded treatment group had significantly higher levels of CPK than both the control and angling groups. The padded treatment group did not show a significantly higher level of LDH than either the control or the angling groups.

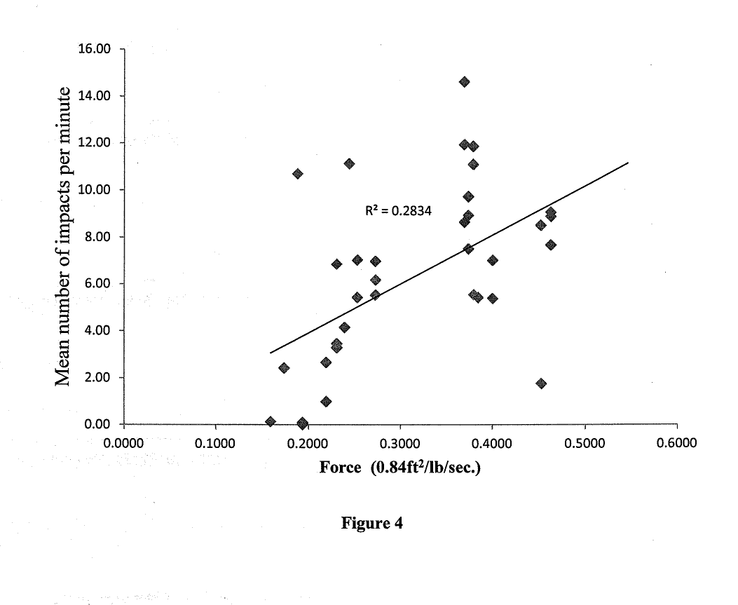

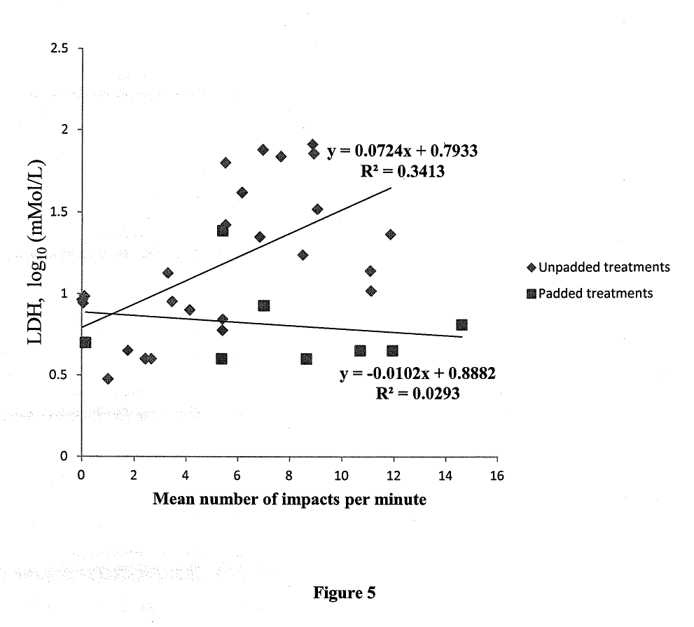

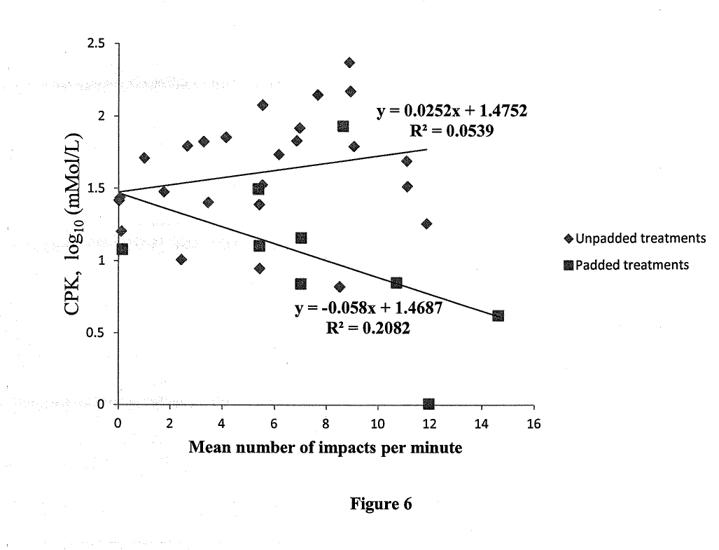

FIG. 4 shows the effect of water activity on the number of impacts between Smallmouth bass and the sides of the experimental livewell. As the amount of water activity increases, so do the mean number of impacts per minute (R²=0.283). The numbers of impacts were related to the amount of cellular damage a fish sustains over a transportation period, as shown by the mean number of impacts per minute and the amount of LDH and CPK found in the plasma of the fish. Here, the treatments are separated into padded and non-padded groups. FIG. 5 shows the relationship between LDH and mean number of impacts per minute, where there was significantly less LDH in plasma of the padded group, indicating less cellular damage. Similarly, FIG. 6 shows the relationship between impacts of the fish with the sides of the livewell and the level of CPK in the plasma, where there was significantly less CPK in plasma of the padded group, indicating less cellular damage.

### 10. Conclusion

The results indicate that plasma levels of LDH and CPK of fish in an unpadded livewell were significantly higher than control levels or levels of fish in a livewell with a padding system as described herein. Because LDH and CPK are indicators of cellular damage (Suski 2004), these results indicate that fish in unpadded livewells experienced significant cellular damage during transportation. Thus, a padding system for a livewell as described herein reduces, minimizes, or eliminates cellular damage caused by livewell transport.

### EQUIVALENTS

While the invention has been described with respect to illustrative embodiments thereof, it will be understood that various changes may be made to the embodiments without departing from the scope of the invention. The described embodiments are to be considered merely exemplary and the invention is not to be limited thereby.

### REFERENCES

Anderson, W. G., R. S. McKinley, M. Colavecchia. 1997. The use of clove oil as an anesthetic for rainbow trout and its effect on swimming performance. American Journal of Fisheries Management 17: 301-307.
Hørder, M., R. C. Elser, W. Gerhardt, M. Mathieu and E. J. Sampson. 1990. IFCC methods for the measurement of catalytic concentrations of enzymes, part 7. IFCC methods for creatine kinase (ATP: creatine N-phosphotransferase EC 2.7.3.2): IFCC recommendation. Clinica Chimica Acta 190: S4-S17.
Kerr, S. J. 1999. A survey of competitive fishing events in Ontario. Technical report TR-114, Southcentral Sciences Section, Ontario Ministry of Natural Resources, Kemptville, Ontario. 11p+Appendices.
Morrissey, M. B., C. D. Suski, K. R. Esseltine, and B. L. Tufts. 2005. Incidence and physiological consequences of decompression in smallmouth bass after live-release angling tournaments. Transaction of the American Fisheries Society 134: 1038-1047.
Suski, C. D. 2004. A physiological investigation of competitive angling events. Ph. D. Thesis. Queen's University. Kingston ON. Canada.
Wróblewski, F. and J. S. LaDue. 1955. Lactic dehydrogenase activity in blood. Proclamations of the Society for Experimental Biology and Medicine 90: 210-213.

1. A livewell for storing and/or transporting live fish, comprising:
a tank comprising walls adapted to contain water and one or more fish; and
a padding system;
wherein the padding system is disposed between at least one wall of the tank and the one or more fish.

2. The livewell of claim 1, further comprising one or more sensors;
wherein the one or more sensors provide monitoring of at least one parameter of the water in the livewell;
wherein the at least one parameter is selected from oxygen, temperature, pH, and ammonia.

3. The livewell of claim 1, further comprising apparatus that performs at least one function selected from circulating, oxygenating, filtering, and chilling water in the livewell.

4. The livewell of claim 3, wherein the apparatus performs a said at least one function in accordance with at least one corresponding sensor.

5. The livewell of claim 1, wherein the padding system substantially covers at least one wall of the livewell.

6. The livewell of claim 1, wherein the padding system substantially covers two or more walls of the livewell.

7. The livewell of claim 1, wherein the padding system includes one or more portions that divide the livewell into two or more chambers, each chamber adapted to accommodate a fish.

8. The livewell of claim 1, wherein the padding system comprises at least one pouch adapted to accommodate a fish.

9. The livewell of claim 8, including a means for stabilizing the at least one pouch in the livewell.

10. The livewell of claim 9, wherein the means for stabilizing the at least one pouch includes a keel, a floatation component, or a combination thereof.

11. The livewell of claim 9, wherein the means for stabilizing the at least one pouch includes one or more members that substantially span a length and/or width of the livewell, and/or one or more members associated with one or more walls of the livewell;
wherein the at least one pouch is removably attachable to the one or more members.

12. The livewell of claim 8, wherein at least one pouch is adapted to be removably attached to at least one other pouch.

13. The livewell of claim 1, wherein at least a portion of the padding system is adapted to be removed from the livewell with a fish therein.

14. The livewell of claim 13, wherein the portion of the padding system that is adapted to be removed from the livewell with a fish therein is a pouch.

15. An insert for a livewell for storing and/or transporting live fish, comprising:
a padding system;
wherein the padding system is adapted to be disposed in the livewell between at least one wall of the livewell and one or more fish.

16. The insert of claim 15, wherein the padding system includes one or more portions that divide the livewell into two or more chambers, each chamber adapted to accommodate a fish.

17. The insert of claim 15, further comprising one or more sensors associated with the padding system;
wherein the one or more sensors provide monitoring of at least one parameter of the water in the livewell;
wherein the at least one parameter is selected from oxygen, temperature, pH, and ammonia.

18. The insert of claim 15, wherein the padding system comprises at least one pouch adapted to accommodate a fish, and optionally includes a means for stabilizing the at least one pouch in the livewell.

19. The insert of claim 18, wherein the means for stabilizing the at least one pouch includes a keel, a floatation component, or a combination thereof.

20. The insert of claim 18, wherein the means for stabilizing the at least one pouch comprises one or more members that substantially span a length and/or width of the livewell, and/or one or more members associated with one or more walls of the livewell;
wherein the at least one pouch is removably attachable to the one or more members.

21. The insert of claim 15, wherein at least a portion of the padding system is adapted to be removed from the livewell with a fish therein.

22. The insert of claim 21, wherein the portion of the padding system that is adapted to be removed from the livewell with a fish therein is a pouch.

23. A method for storing and/or transporting live fish, comprising:
placing fish in a livewell comprising walls that contain water and a padding system; and
disposing the padding system between at least one wall of the livewell and the fish;
wherein the padding system protects fish against impacts with the walls of the livewell.

24. The method of claim 23, including substantially covering at least one inside wall of the livewell with the padding system.

25. The method of claim 23, including configuring the padding system to divide the livewell into two or more chambers, each chamber adapted to accommodate a fish.

26. The method of claim 23, comprising providing one or more sensors with the padding system or the livewell;
wherein the one or more sensors provide monitoring of at least one parameter of the water in the livewell;
wherein the at least one parameter is selected from oxygen, temperature, pH, and ammonia.

27. The method of claim 26, including one or more of circulating, oxygenating, filtering, and chilling water in the livewell so as to maintain the at least one parameter at, above, or below a selected level, or within a selected range;
optionally wherein one or more of circulating, oxygenating, filtering, and chilling water is carried out when a level of the at least one parameter is sensed to deviate from the selected level or the selected range.

28. The method of claim 23, including removing the padding system or a portion thereof from the livewell with a fish therein.

29. The method of claim 23, comprising placing a fish in a pouch of the padding system.

30. The method of claim 29, including providing a means for stabilizing the at least one pouch in the livewell.

31. The method of claim 29, including providing a means for stabilizing the at least one pouch, comprising:
a keel or a floatation component associated with the at least one pouch, or a combination thereof; and/or
one or more members that substantially span a length and/or width of the livewell, and/or one or more members associated with one or more walls of the livewell;
wherein the at least one pouch is removably attachable to the one or more members.

32. The method of claim 29, including removably attaching together two or more pouches.
